(19) United States
(12) Patent Application Publication
(10) Pub. No.: US 2013/0053199 A1
(43) Pub. Date: Feb. 28, 2013

(54) Independent Pulley System With Clutches

(71) Applicant: Valerie M. Thompson, Solana Beach, CA (US)

(72) Inventor: Valerie M. Thompson, Solana Beach, CA (US)

(21) Appl. No.: 13/219,454

(22) Filed: Aug. 26, 2011

(51) Int. Cl. F16H 7/00; F16H 55/32; F16D 23/00

(52) U.S. Cl. 474/148; 192/30 R

(57) ABSTRACT

The present invention relates to a pulley system including a motor, pulleys having a clutch, and pulley applications. The motor can be a truck motor such as a diesel motor using a power take-off (PTO) system. The motor provides power to the pulleys, and when the clutch is engaged on one or more pulleys corresponding to one or more selected pulley applications, the motor powers the selected pulley applications. The clutches allow the pulley system to independently power any number of the pulley applications by simply engaging the clutches corresponding to the desired pulley applications. The pulley applications can include cleaning applications, such as power wash pumps, an insulation removal vacuum, a generator, a water recovery vacuum, and an air compressor.

### BACKGROUND OF THE INVENTION

1. Field of Invention

The present invention relates generally to a pulley system, and specifically to a pulley system with clutches for independent engagement of pulley applications.

2. Description of Related Art

A pulley, also called a sheave or a drum, is a mechanism composed of a wheel on an axle or shaft that may have one or more grooves between two flanges around its circumference. A rope, cable, belt, or chain usually runs over the wheel and inside the grooves. Pulleys are used to change the direction of an applied force, transmit rotational motion, or realize a mechanical advantage in either a linear or rotational system of motion. In a belt and pulley system, for example, two or more pulleys are in common to a belt and allows for mechanical power, torque, and speed to be transmitted across axles.

Pulleys can be fixed, movable, or a combination of fixed and movable. A fixed pulley has a fixed axle, meaning the axle is anchored in place and the force is equal on both sides of the pulley. A movable pulley has a free axle, meaning the axle is free to move in space and can have multiple times the force on the output of the pulley as received on the input of the pulley. A pulley with both fixed and movable features is a compound pulley, an example of a compound pulley being a block and tackle pulley, where several pulleys are mounted on each axle, further increasing the mechanical advantage.

A clutch is a mechanical device which provides for the transmission of power and motion from a driving component to a driven component. The opposite component of the clutch is a brake. Clutches are used for controlling the transmission of power, motion, and torque. For example, clutches control whether automobiles transmit engine power to the wheels, and clutches on electric screwdrivers limit how much torque is transmitted.

In the commercial and industrial cleaning business, conventionally a truck has a cleaning application, such as a pressure wash pump, vacuum, generator, or air compressor. Conventionally, the truck can only power a limited number of applications, such that there is typically only one cleaning application per truck, meaning there are multiple types of cleaning trucks for each cleaning purpose (e.g., one truck for carpet cleaning, one truck for tile and grout cleaning, one truck for power washing, one truck for air duct cleaning, one truck for insulation, etc.). As such, cleaning crews are limited to the applications that the truck on site provides. If the job can be perform better with additional trucks, or the customer wishes to purchase additional services, typically the service is not performed properly or at all, since bringing in a new truck can be more trouble than it's worth.

U.S. Pat. No. 5,657,505 to Gallagher is directed to a drain cleaning apparatus, which rotates a drain cleaning snake. The drain cleaning apparatus has two clutch actuators with a radially expandable and contractible clutch in between for engaging and disengaging the drain cleaning snake. A motor drives the first clutch actuator through a transmission pulley and belt arrangement in which the belt is axially slidable relative to a pulley in response to axial displacement of the first clutch actuator relative to the second clutch actuator. However, the Gallagher apparatus uses a motor with clutches to engage and disengage a single cleaning application, and would not work with multiple cleaning applications.

It would be highly desirable to have a pulley system that could engage and disengage several selected cleaning applications, such that a single motor could power several independent applications through independent pulleys.

### SUMMARY OF THE INVENTION

Embodiments of the present invention include a pulley system including a motor, pulleys having a clutch, and pulley applications. The motor can be a truck motor such as a diesel motor using a power take-off (PTO) system. The motor provides power to the pulleys, and when the clutch is engaged on one or more pulleys corresponding to one or more selected pulley applications, the motor powers the selected pulley applications. The clutches allow the pulley system to independently power any number of the pulley applications by simply engaging the clutches corresponding to the desired pulley applications. The pulley applications can include cleaning applications, such as power wash pumps, an insulation removal vacuum, a generator, a water recovery vacuum, and an air compressor.

In an embodiment, a system comprises: a motor configured to provide rotational power; a plurality of pulleys connected to the motor, the plurality of pulleys configured to receive rotational power; a plurality of clutches attached to the plurality of pulleys, the plurality of clutches configured to engage the plurality of pulleys such that the plurality of pulleys provide rotational power, wherein a selected number of the plurality of pulleys are engaged, the selected number of the plurality of pulleys corresponding to a number of engaged clutches; and a plurality of pulley applications connected to the plurality of pulleys, the plurality of pulley applications configured to receive rotational power from the plurality of pulleys, wherein a number of pulley applications receiving rotational power corresponding to the selected number of the plurality of pulleys. The motor may comprise a truck motor, and the truck motor may power a power take-off The power take-off may provide rotational power to the plurality of pulleys. The plurality of pulleys may comprise a drive pulley and a receive pulley. The number of pulley applications receiving rotational power may be greater than zero and less than all of the plurality of pulley applications. Each of the plurality of pulleys may comprise one of the plurality of clutches. The plurality of pulley applications may be selected from a group consisting of: one or more power wash pumps, a water recovery vacuum, an insulation removal vacuum, a generator, an air compressor, and combinations thereof. The system may further comprise a flow rate changer.

In another embodiment, a method comprises the steps of: providing rotational power using a motor; receiving rotational power from the motor at a plurality of pulleys; engaging the plurality of pulleys using a plurality of clutches, wherein a selected number of the plurality of pulleys are engaged, the selected number of the plurality of pulleys corresponding to a number of engaged clutches; and receiving rotational power from the selected number of the plurality of pulleys at a plurality of pulley applications. The motor may comprise a truck motor, and the truck motor may power a power take-off. The power take-off may provide rotational power to the plurality of pulleys. Each of the plurality of pulleys may comprise one of the plurality of clutches.

In another embodiment, a device comprises: a drive pulley configured to receive rotational power from a motor; a receive pulley connected to the drive pulley, the receive pulley configured to receive rotational power from the drive pulley and configured to drive a pulley application; and a clutch attached to at least one of the drive pulley or receive pulley, the clutch configured to engage a selected pulley application. The motor may comprise a truck motor. The drive pulley may comprise the clutch and the receive pulley may comprise the clutch.

An advantage of the present invention is that it allows one truck motor to drive multiple cleaning applications. For example, one truck can now do what conventionally would take several cleaning trucks to do. For example, conventionally there is a truck for carpet cleaning, a truck for tile and grout cleaning, a truck for power washing, a truck for air duct cleaning, and a truck for insulation. Now, these applications can be performed with just one cleaning truck. The unique pulley system and clutches allow several pulleys to drive selected cleaning applications simultaneously, individually, or in any combination. For example, if the truck has eight cleaning applications, the pulley can drive one, two, three, four, five, six, seven, or all eight applications at one time. This is especially useful because cleaning crews often notice the need for additional services while cleaning after the truck has already arrived, and customers often wish to purchase additional services impulsively at the time of cleaning, such that it would be too late to bring out another cleaning truck.

The foregoing, and other features and advantages of the invention, will be apparent from the following, more particular description of the preferred embodiments of the invention, the accompanying drawings, and the claims.

### BRIEF DESCRIPTION OF THE DRAWINGS

FIG. 1 illustrates a pulley system for powering one or more pulley applications according to one embodiment of the invention.

FIG. 2 illustrates the pulleys within the system according to one embodiment of the invention.

FIG. 3 illustrates the pulley applications within the system according to one embodiment of the invention.

FIG. 4 illustrates a flow chart showing a process of engaging a selected pulley application according to an embodiment of the invention.

### DETAILED DESCRIPTION OF THE INVENTION

Before the present composition, methods, and methodologies are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Unless defined otherwise, all technical and scientific terms used herein have the same meaning as commonly understood by one of ordinary skill in the art to which this invention belongs. Any methods and materials similar or equivalent to those described herein can be used in the practice or testing of the invention, as it will be understood that modifications and variations are encompassed within the spirit and scope of the instant disclosure.

The present invention relates to a pulley system including a motor, pulleys having a clutch, and pulley applications. The motor can be a truck motor such as a diesel motor using a power take-off (PTO) system. The motor provides power to the pulleys, and when the clutch is engaged on one or more pulleys corresponding to one or more selected pulley applications, the motor powers the selected pulley applications. The clutches allow the pulley system to independently power any number of the pulley applications by simply engaging the clutches corresponding to the desired pulley applications. In other words, when a clutch of a rotating pulley is engaged, that pulley provides power to the associated pulley application. When the clutch of a rotating pulley is not engaged, that pulley does not provide power to the associated pulley application. For example, in an embodiment with eight pulley applications and eight clutches, engaging two of the eight clutches would power those two pulley applications. The pulley applications can include cleaning applications, such as power wash pumps, an insulation removal vacuum, a generator, a water recovery vacuum, and an air compressor.

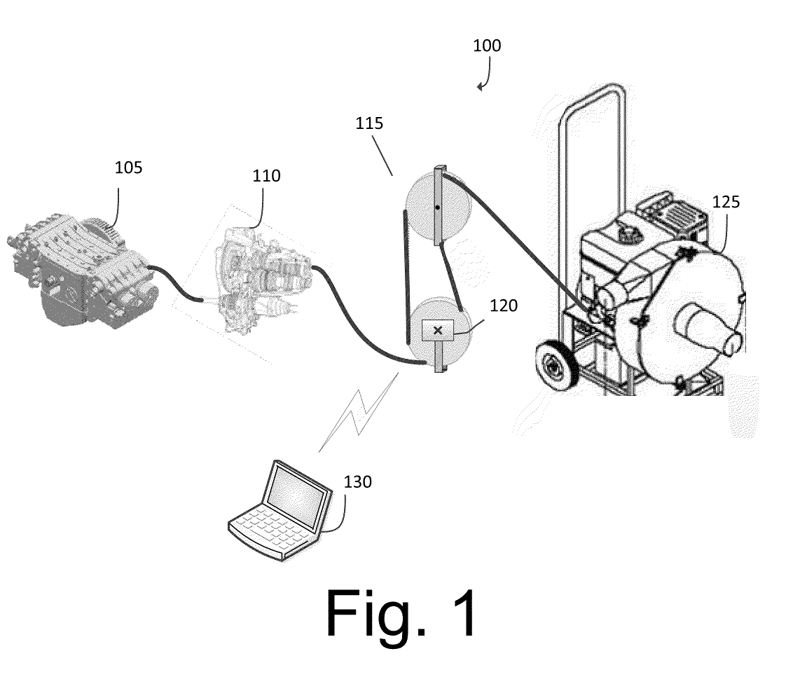

FIG. 1 illustrates a pulley system 100 for powering one or more pulley applications 125 according to one embodiment of the invention. The system 100 (e.g., drivetrain system) includes a truck motor 105, a secondary transmission 110, pulleys 115, one or more clutches 120, one or more pulley applications 125, and a control panel 130. The system 100 provides independent powering of a selected number of the pulley applications 125 based on which of the pulleys 115 have their clutches 120 engaged.

The truck motor 105 can be any type of motor providing rotational power, such as a diesel motor using a power take-off (PTO) system. Power take-off is typically a splined driveshaft, usually on a truck or tractor that can be used to provide power to an attachment or separate machine. It is designed to be easily connected and disconnected. The power take-off allows implements to draw energy from the truck's engine. The power take-off conventionally powers a primary truck transmission (not shown) which powers the truck's wheels. The truck motor 105 powers the secondary transmission 110. The secondary transmission 110 is configured to rotate the pulleys 115.

The pulleys 115 can be connected to or part of four driveshafts on a drivetrain. The pulleys 115 can be several sets of drive pulleys and receive pulleys, each set operating independently in parallel. The pulleys 115 represent the independent pulleys configured to provide rotational power to the pulley applications 125. For example, a driveshaft can provide rotational power to a receiver pulley having four grooves with two incoming belts and two outgoing belts, which provides power to a cleaning application. In one embodiment, the pulleys 115 rotate counter-clockwise.

The clutches 120 can activate the pulleys 115 (e.g., driveshafts) and can be an electromagnetic clutch embedded within the pulleys 115. The electromagnetic clutch can have a magnet inside configured to be attached to a pulley application 125. Each of the clutches 120 can be mounted inside of the pulleys 115. For example, the outer perimeter of a clutch can mount to a step on an inner ring of a pulley. For some pulley applications 125, e.g., power wash pumps, the clutches can be centrally mounted using mounting brackets, a spacer, and shaft extensions to ensure even power distribution to each of the pulley applications 125 and to run several pulley applications 125 individually or simultaneously. The pulley applications 125 can be cleaning applications, such as an insulation removal vacuum.

The control panel 130 communicates with, controls, and monitors the operation of the system 100. The control panel 130 can create a wired or wireless connection with the system 100. The control panel 130 can access the Internet to control and monitor the system 100 from a remote location. For example, the control panel 130 can engage or disengage one or more of the clutches 120 to engage or disengage one or more selected pulley applications 125. Advantageously, since the system 100 is independently run in parallel with clutches 120, the system 100 allows a selected number of pulley applications to run at once, and is not limited to running all or none of pulley applications at once, like in conventional pulleys.

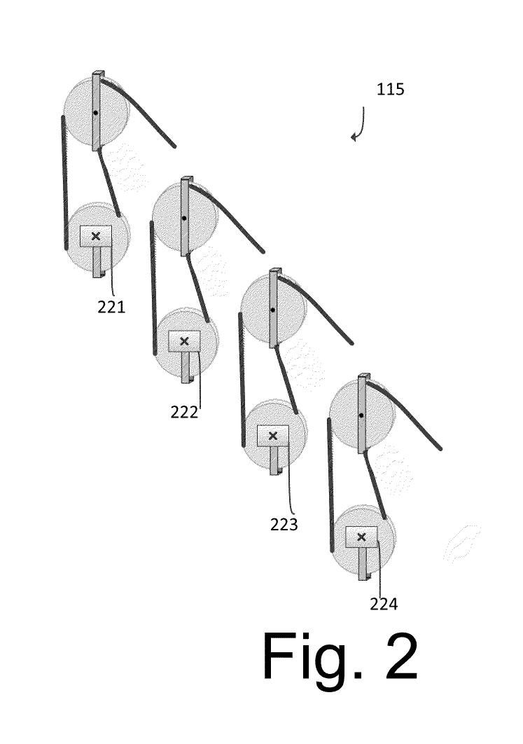

FIG. 2 illustrates the pulleys 115 within the system 100 according to one embodiment of the invention. The pulleys 115 are operating in parallel, independent of each other. The pulleys 115 have clutches 221-224, where the clutches 221-224 control which pulleys are engaged and which are disengaged. By engaging a clutch of a selected pulley, the selected pulley is engaged, which engages the corresponding pulley application 125. In other words, the clutches 221-224 allow an operator to turn a specific pulley application on or off by simply engaging or disengaging the clutch corresponding to the specific pulley application. Although the pulleys 115 are shown with four clutches 221-224, other number of clutches could also be used with the pulleys 115 to further engage and brake the pulley applications 125. In one embodiment, one clutch per pulley application 125 is used. Although, more or less than one clutch per pulley application can be used. In addition to the clutches 221-224 providing full engagement and disengagement of the selected pulleys, the clutches 221-224 can also more specifically control the revolutions per minute (RPM) of the spinning pulleys 115. For example, three of four sets of pulleys can operate at a first RPM, and the fourth set of pulleys can operate at a second RPM.

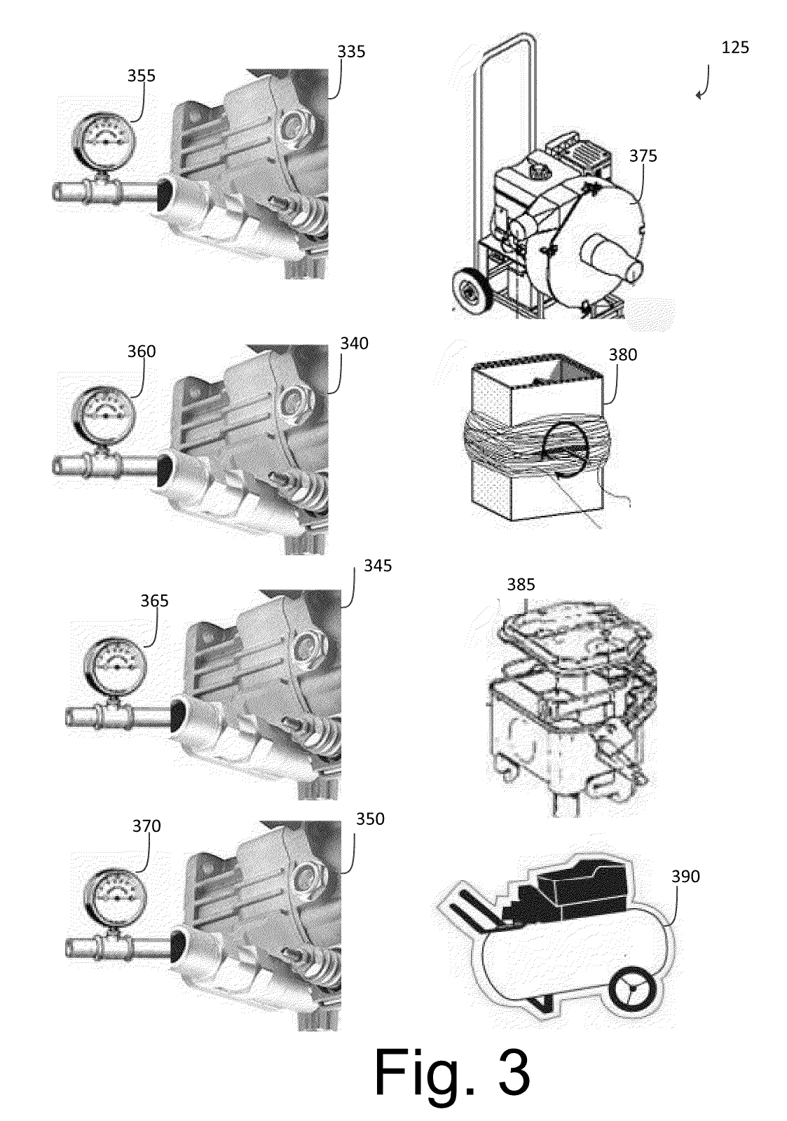

FIG. 3 illustrates eight pulley applications 125 within the system 100 according to one embodiment of the invention. The pulley applications 125 comprise four power wash pumps 335-350 comprising flow rate changers 355-370, an insulation removal vacuum 375, a generator 380, a water recovery vacuum 385, and an air compressor 390. One of ordinary skill in the art appreciates that other types of pulley applications 125 can be implemented in the system 100. In one embodiment, the control panel 130 activates the four power wash pumps 335-350, the insulation removal vacuum 375, the generator 380, the water recovery vacuum 385, and the air compressor 390 simultaneously. In another embodiment, the control panel 130 activates some, but less than all, of the pulley applications 125. Each of the pulley applications 125 are engaged by engaging a clutch corresponding to that pulley application. The flow rate changers 355-370 on the power wash pumps 335-350 control the water's volume and pounds per square inch (PSI) pressure. The flow rate changes 355-370 allow the water volume and pressure to be set based on the job. For example, tile and grout cleaning and power washing a house require a high PSI of water, but carpet cleaning requires a low PSI of water.

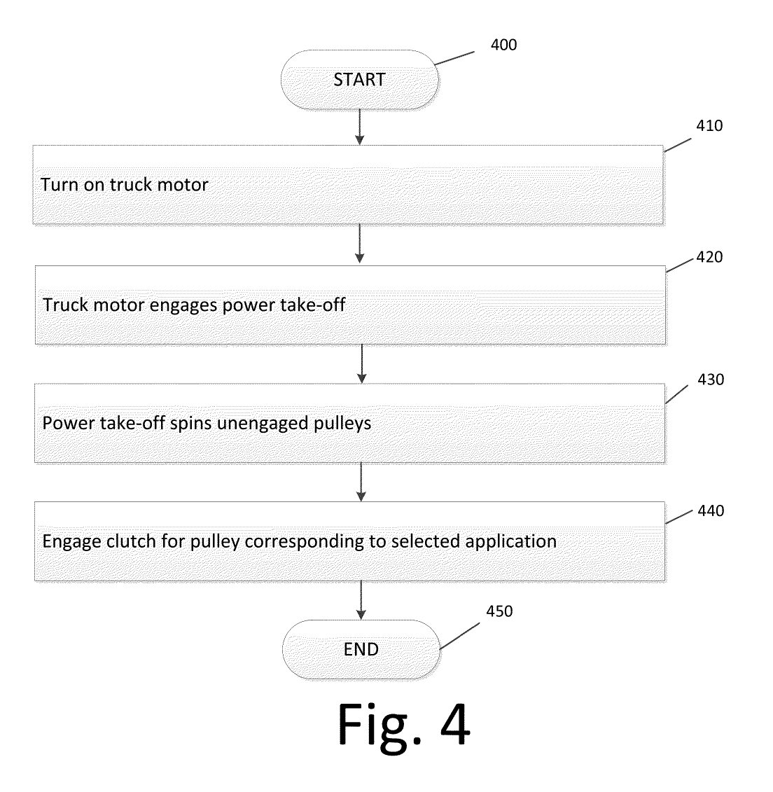

FIG. 4 illustrates a flow chart showing a process of engaging a selected pulley application according to an embodiment of the invention. The process starts at step 400. At step 410, the operator turns on the truck motor 105. At step 420, the truck motor 105 engages the power take-off. The power take-off can be engaged through the cruise control of the truck motor 105, which controls the speed. The power take-off provides rotational power through the secondary transmission 110 and rotates the pulleys 115 at step 430. In one embodiment, the pulleys 115 can start off being unengaged by any of the clutches 120, such that the power take-off spins unengaged pulleys 115. Then at step 440, the control panel 130 engages one or more of the clutches 120 to engage a selected number of pulley applications 125. The process ends at step 450.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, for example, through multi-threaded processing, interrupt processing, or multiple processors, rather than sequentially.

The steps of a method or algorithm described in connection with the embodiments disclosed herein may be embodied directly in a computer or electronic storage, in hardware, in a software module executed by a processor, or in a combination thereof. A software module may reside in a computer storage such as in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

It should be understood that the invention is not limited to the embodiments set forth herein for purposes of exemplification, but is to be defined only by a fair reading of the appended claims, including the full range of equivalency to which each element thereof is entitled. Although the invention has been described with reference to the above examples, it will be understood that modifications and variations are encompassed within the spirit and scope of the invention. Accordingly, the invention is limited only by the following claims.

I claim herein:

1. A system comprising:
a motor configured to provide rotational power;
a plurality of pulleys connected to the motor, the plurality of pulleys configured to receive rotational power;
a plurality of clutches attached to the plurality of pulleys, the plurality of clutches configured to engage the plurality of pulleys such that the plurality of pulleys provide rotational power, wherein a selected number of the plurality of pulleys are engaged, the selected number of the plurality of pulleys corresponding to a number of engaged clutches; and
a plurality of pulley applications connected to the plurality of pulleys, the plurality of pulley applications configured to receive rotational power from the plurality of pulleys, wherein a number of pulley applications receiving rotational power corresponding to the selected number of the plurality of pulleys.

2. The system of claim 1, wherein the motor comprises a truck motor.

3. The system of claim 2, wherein the truck motor powers a power take-off.

4. The system of claim 3, wherein the power take-off provides rotational power to the plurality of pulleys.

5. The system of claim 1, wherein the plurality of pulleys comprise a drive pulley and a receive pulley.

6. The system of claim 1, wherein the number of pulley applications receiving rotational power is greater than zero and less than all of the plurality of pulley applications.

7. The system of claim 1, wherein each of the plurality of pulleys comprise one of the plurality of clutches.

8. The system of claim 1, wherein the plurality of pulley applications are selected from a group consisting of: one or more power wash pumps, a water recovery vacuum, an insulation removal vacuum, a generator, an air compressor, and combinations thereof.

9. The system of claim 1, further comprising a flow rate changer.

10. A method comprising:
providing rotational power using a motor;
receiving rotational power from the motor at a plurality of pulleys;
engaging the plurality of pulleys using a plurality of clutches, wherein a selected number of the plurality of pulleys are engaged, the selected number of the plurality of pulleys corresponding to a number of engaged clutches; and
receiving rotational power from the selected number of the plurality of pulleys at a plurality of pulley applications.

11. The method of claim 10, wherein the motor comprises a truck motor.

12. The method of claim 11, wherein the truck motor powers a power take-off.

13. The method of claim 12, wherein the power take-off provides rotational power to the plurality of pulleys.

14. The method of claim 10, wherein each of the plurality of pulleys comprise one of the plurality of clutches.

15. A device comprising:
a drive pulley configured to receive rotational power from a motor;
a receive pulley connected to the drive pulley, the receive pulley configured to receive rotational power from the drive pulley and configured to drive a pulley application; and
a clutch attached to at least one of the drive pulley or receive pulley, the clutch configured to engage a selected pulley application.

16. The device of claim 15, wherein the motor comprises a truck motor.

17. The device of claim 15, wherein the drive pulley comprises the clutch.

18. The device of claim 15, wherein the receive pulley comprises the clutch.
